(19) United States
(12) Patent Application Publication
(10) Pub. No.: US 2024/0250588 A1
(43) Pub. Date: Jul. 25, 2024

(54) INSTALLATION AND METHOD FOR PRODUCING LAMINATED CORES, BONDED OVER THEIR ENTIRE SURFACE, FOR AN ELECTRICAL MACHINE

(71) Applicant: ZF Friedrichshafen AG, Friedrichshafen (DE)

(72) Inventors: Christian BENKERT, Waigolshauen (DE); Felix Viebahn, Schonungen (DE)

(21) Appl. No.: 18/414,814

(22) Filed: Jan. 17, 2024

(30) Foreign Application Priority Data
Jan. 24, 2023 (DE) 10 2023 200 542.5

(51) Int. Cl. H02K 15/02; H02K 15/12

(52) U.S. Cl. CPC H02K 15/02; H02K 15/12; H02K 2215/00

(57) ABSTRACT

A installation for producing laminated cores, bonded over their entire surface, for an electrical machine, comprising: a workpiece carrier for receiving a semi-finished product and for applying a defined axial prestressing force to the semi-finished product, the semi-finished product having a plurality of electrical sheet laminations coated with Backlack, and at least two stations, comprising a heating station for heating the semi-finished product and a cooling station for energy-assisted cooling of the semi-finished product, wherein the at least two stations are arranged spatially separated from one another and are passed through by the workpiece carrier.

### BACKGROUND OF THE INVENTION

### 1, Field of the Invention

The disclosure relates to an installation for producing laminated cores, bonded over their entire surface, for an electrical machine and to a method for producing laminated cores, bonded over their entire surface, for an electrical machine.

### 2. Description of Related Art

To generate efficient electrical machines, it is necessary to create laminated cores from individual laminations with low sheet thicknesses, or rather core laminations, in order to minimize eddy current losses.

Known packaging processes include punch packaging and packaging by laser welding. However, these processes both have the disadvantage that the magnetic properties are adversely affected during production.

In the so-called Backlack process, laminations of electrical steel strips are coated with a thin layer of adhesive on both sides, if possible over the entire surface, and pressed together. Uniform hardening of the adhesive is usually achieved by heating the pressed-together lamination pack. This makes it possible to obtain stable laminated cores with good magnetic properties.

Known installations for producing such a laminated core are usually based on a device in which a lamination pack coated with Backlack (bonding varnish) is pressed together. The device is also heated to harden the Backlack.

Such a device is described in US 2022/0186762 A1. A lamination stack is placed in a stacking and packing unit. The stacking and packing unit is heated and an elevated temperature is maintained. The lamination stack is then cooled. Pressure is exerted on the lamination stack over the entire period.

A disadvantage is that the degree of utilization of the components used is low. For example, one component of the device that is used to heat the stack of sheets must be inactive during the cooling phase. Heating and cooling in the same room or within the same device also require an increased use of energy, as the other component or components must be unnecessarily heated or cooled. The unnecessary heating or cooling of the components increases their wear and requires more time. In order to minimize process times, cooling must be supported energetically, in particular the component must be actively cooled. Another disadvantage is the difficulty in adapting the device, for example to lamination packs having different dimensions. This severely limits the possible applications of the device.

### SUMMARY OF THE INVENTION

An object of the present disclosure is an installation and a method with optimum spatial and temporal utilization of the components of the installation, lower energy consumption, and less wear.

In accordance with one aspect of the invention, this object is achieved by an installation and a method for producing laminated cores, bonded over their entire surface, for an electrical machine. Advantageous embodiments and developments of the invention can be found in the dependent claims.

One aspect of the invention relates to an installation for producing laminated cores, bonded over their entire surface, for an electrical machine, comprising a workpiece carrier for receiving a semi-finished product and applying a defined axial prestressing force to the semi-finished product, wherein the semi-finished product has a plurality of electrical steel laminations coated with Backlack, and at least two stations, comprising a heating station for heating the semi-finished product and a cooling station for cooling the semi-finished product with energy assistance, wherein the at least two stations are arranged spatially separated from one another and are passed through by the workpiece carrier.

One aspect of the invention relates to a method for producing laminated cores, bonded over their entire surface, for an electrical machine, comprising the steps of providing a workpiece carrier, which is adapted to receive a semi-finished product, and to apply a defined axial prestressing force to the semi-finished product, wherein the semi-finished product has a plurality of electrical steel laminations coated over their entire surface with Backlack, and the workpiece carrier passes through at least two stations for heating the semi-finished product in a heating station and for cooling the semi-finished product in a cooling station with energy assistance, wherein the at least two stations are spatially separated from one another.

Preferably, the laminated cores, bonded over their entire surface, can be used for a stator and/or rotor of an electrical machine. Further examples of an electrical machine include a transformer. Preferably, the heating station and the cooling station are adapted to perform the described function.

The installation can be used to mass-produce laminated cores consisting of electrical steel laminations coated on both sides with a Backlack, e.g. an epoxy resin. During production, the individual laminations are baked together under the effect of an axial prestressing force and at elevated temperatures, wherein the applied layers of varnish on adjacent laminations react with each other and are thus bonded. By fusing the adjacent layers of varnish, the actual lamination pack can be formed as a laminate. Preferably, the lamination pack can be cooled to a certain temperature after the actual bonding process before the prestressing force is removed.

Both the temperature control within the lamination pack and the application of the prestressing force can be homogeneous. Preferably, the two variables (prestressing) force and temperature can be controlled for this purpose. For example, and preferably, the force to be applied to the lamination pack can be successively reduced, for example after the reaction start temperature of the varnish has been reached, in order to prevent the liquefied varnish from being squeezed out of the lamination pack from the side.

The installation and the method have the advantage that, due to the spatial separation of the individual temperature zones for heating or baking in the heating station and the energy-assisted cooling in the cooling station, these stations can be kept at the appropriate temperature. The energy consumption and also the wear of the stations can be kept to a minimum, as only the workpiece carrier with the semi-finished product inside is subjected to a temperature change. Due to the spatial separation of the individual process steps, these can also be scaled and multiplied more easily than the process steps that take place in a stationary device. This means, for example, that individual stations do not have to be occupied for longer than necessary for the respective process step. For example, if a longer cooling phase is required, the corresponding cooling section can be extended regardless of the number of spaces in the continuous furnace. Similarly, individual stations can also be removed. This modular design enables greater flexibility than the installations known from the prior art. The installation and the method can easily be used to produce rotor or stator laminations for different product groups, as only a few components of the installation need to be adapted to the size of the respective component.

According to one aspect, the installation comprises a loading station for loading a workpiece carrier with a semi-finished product, a checking station for checking the height of a semi-finished product, a closing station for closing a workpiece carrier, a warming station for warming a semi-finished product, an opening station for opening a workpiece carrier, and/or a removal station for removing a semi-finished product, wherein the loading station, checking station, closing station and/or warming station are arranged upstream of the heating station, wherein the opening station and/or removal station are arranged downstream of the cooling station. Preferably, the respective stations are adapted to perform the described function. Preferably, some of the aforementioned stations may be included more than once, wherein these are usually arranged one behind the other. The closing station and the opening station can have a common device with which the tool carrier can be closed or opened. The loading station and the removal station can also have a common device for inserting a semi-finished product into the tool carrier or removing the semi-finished product. Preferably, the inserting station and the removal station are adjacent to each other. The warming station can comprise an induction heater to quickly heat the tool carrier to a temperature below that of the heating station. A preferred installation may comprise a loading station, a checking station, a closing station, a warming station, a heating station, a cooling station, an opening station and a removal station in the order stated. It is clear that the functions of some of the aforementioned stations can also be combined in one station, for example, checking the height of the semi-finished product and closing the tool carrier can take place in one station.

A warming station, which is preferably designed for induction warming of the semi-finished product, is preferably located upstream of the heating station, which can be designed as a continuous furnace, for example. Induction warming provides a high heating capacity, which means that the semi-finished product can be heated quickly. As the inductor is only used for rapid preheating of the semi-finished product, the inductor can continuously provide high power. In addition, the heating station, e.g. a continuous furnace, can remain at a constant temperature and not undergo any heating and cooling processes. As a result, energy can be saved and the production of laminated cores, bonded over their entire surface, for an electrical machine can be accelerated. Component wear can be reduced.

According to one aspect, the workpiece carrier has a base plate with a first side and a second side facing away from the first side, wherein the prestressing unit is arranged on the first side and the second side is designed to receive the semi-finished product and to apply the defined axial prestressing force to the semi-finished product by the prestressing unit. The installation can have a transport system, e.g. a rail system, on which the base plate of the workpiece carrier can be moved automatically or manually. Preferably, the rail system has the at least two stations in such a way that the semi-finished product picked up on the second side passes through the at least two stations. The workpiece carrier can also have a pressing plate on the second side of the base plate, formed adjacently to the base plate, and a cover, preferably closable, spaced from the pressing plate. The pressing plate can be formed in several parts. A receptacle formed between the pressing plate and the cover can be loaded with the semi-finished product. Furthermore, a centring device can be arranged adjacently to the receptacle. This centring device can be formed vertically on the base plate between the pressing plate and the cover. The use of the centring device can enable precise alignment of the semi-finished product in the receptacle. On the one hand, the spatial separation of the prestressing unit from the semi-finished product by the base plate arranged in between enables easy movement of the workpiece carrier between the at least two stations with a transport system of the installation. In addition, one or more stations, in particular the heating station and/or the cooling station, can be arranged on the transport system in such a way that only the first side of the base plate with the semi-finished product arranged thereon passes through the one or more stations, in particular the heating station and/or the cooling station. This means that only a partial area of the workpiece carrier has to be thermally treated, e.g. warmed, heated and/or cooled. On the one hand, this can speed up the passage through the stations and, on the other hand, save energy. In addition, the thermal load on the prestressing unit, e.g. a hydraulic cylinder and the hydraulic fluid, in particular hydraulic oil, can be reduced or eliminated.

According to one embodiment, the installation comprises a hydraulic system, which is effectively connected to the prestressing unit via connecting lines in such a way that the prestressing unit applies the defined axial prestressing force to the semi-finished product. For this purpose, the prestressing unit can have a hydraulic unit with a hydraulic cylinder, which is connected to the hydraulic system via the connecting lines. The hydraulic system can be connected to a pump, valves and closed-loop or open-loop control components for providing closed-loop and/or open-loop control of the pressure prevailing in the hydraulic cylinder and can be equipped with corresponding measurement technology, e.g. a pressure sensor. The connecting lines can include, for example, a hydraulic line or hose line and possibly electrical lines. Preferably, a prestressing unit of at least one workpiece carrier is permanently connected to the hydraulic system. This allows the prestressing force to be set and/or changed as required. In addition, a single hydraulic system can be used to provide several workpiece carriers with the prestressing force, which further simplifies the installation and involves fewer components. A further advantage of the hydraulic system is the high power density that can be achieved, i.e. in the present case a high prestressing force with a small installation space and weight, which makes the workpiece carrier smaller and lighter and therefore easier to move.

According to one aspect, the at least two stations surround the hydraulic system in such a way that a distance between the hydraulic system and the workpiece carrier is substantially constant. For example, the at least two stations can surround the hydraulic system in a substantially circular shape. Substantially circular includes polygonal, e.g. quadrangular or hexagonal, arrangements of the at least two stations around the hydraulic system. This allows several work stations to pass through the at least two stations without interference. For example, hydraulic lines that connect the hydraulic system to the workpiece carrier can be routed without interacting with other such hydraulic lines that are arranged between the hydraulic system and other workpiece carriers. Additional stations can be added or removed as required.

According to one aspect, the installation has a transport system for the workpiece carrier, preferably with the transport system being designed as a rail system. The base plate of the workpiece carrier can be arranged on the transport system, e.g. a rail system with two or more rails, so that it can be moved automatically or manually. This facilitates the simultaneous use of several workpiece carriers in a single installation. The transport system can surround the hydraulic system in a substantially circular shape. The substantially circular arrangement of the transport system around the hydraulic system also allows connecting lines between the respective workpiece carriers and the hydraulic unit to be moved without interference.

According to one aspect, the heating station has a through-opening along one side thereof, wherein the workpiece carrier has a base plate which at least partially closes the through-opening. Here, the prestressing unit of a tool carrier is preferably arranged on a first side of the base plate and the semi-finished product on a second side of the base plate facing away from the first side. The base plate can be designed here as an assembly which has one or more structuring plates, e.g. a steel plate, and an insulating plate, e.g. made of a heat-insulating material. The steel plate can absorb loads and provide shaping properties. As a result, the area of the tool carrier to be heated can be limited substantially to the second side of the base plate with the semi-finished product arranged on it and under prestress. A thermal load on the first side of the base plate with the prestressing unit arranged on it, in particular a hydraulic cylinder, a hydraulic fluid and/or a sensor system, can thus be avoided.

According to one aspect, several workpiece carriers pass through the installation at the same time, preferably with one station being passed through simultaneously by the several workpiece carriers. This enables improved utilization of the installation. If, for example, the individual cycle of a process is twice as long as the overall cycle of the installation, the process should be run through by two workpiece carriers at the same time so that this process does not represent a “bottleneck”.

According to one aspect, the semi-finished product is heated in the heating station to a temperature that lies within a temperature range of around 200° ° C. The temperature range around 200° C. can range from 175° C. to 225° C., for example from 190° C. to 220° C. The temperature is preferably selected depending on the Backlack used.

The term “semi-finished product” can be used to refer to the lamination packs or core laminations coated with Backlack before the Backlack hardens by reaching the reaction start temperature for the first time. The term “finished product” can refer to the laminated cores, bonded over their entire surface, which are obtained after the Backlack has hardened.

In the heating station, the semi-finished product is preferably heated to and/or above the reaction start temperature of the Backlack. More preferably, the heating station is designed as a furnace, in particular as a continuous furnace.

The cooling station can enable energy-assisted cooling of the semi-finished product, e.g. to room temperature. For this purpose, the cooling station can preferably include a fan. The use of several cooling stations enables a simple and cost-effective design of the individual cooling stations compared to a single cooling station (or a small number of cooling stations).

### BRIEF DESCRIPTION OF THE DRAWINGS

The invention is explained in detail below by way of example with reference to several figures, in which:

FIG. 1 is a schematic representation of a workpiece carrier for an installation for producing laminated cores, bonded over their entire surface, for an electrical machine;

FIG. 2 is a schematic plan view of an installation for producing laminated cores, bonded over their entire surface, for an electrical machine;

FIG. 3 is a schematic side view of a detail of the installation shown in FIG. 2; and

FIG. 4 is a schematic oblique view of the heating station shown in FIG. 2.

### DETAILED DESCRIPTION OF THE PRESENTLY PREFERRED EMBODIMENTS

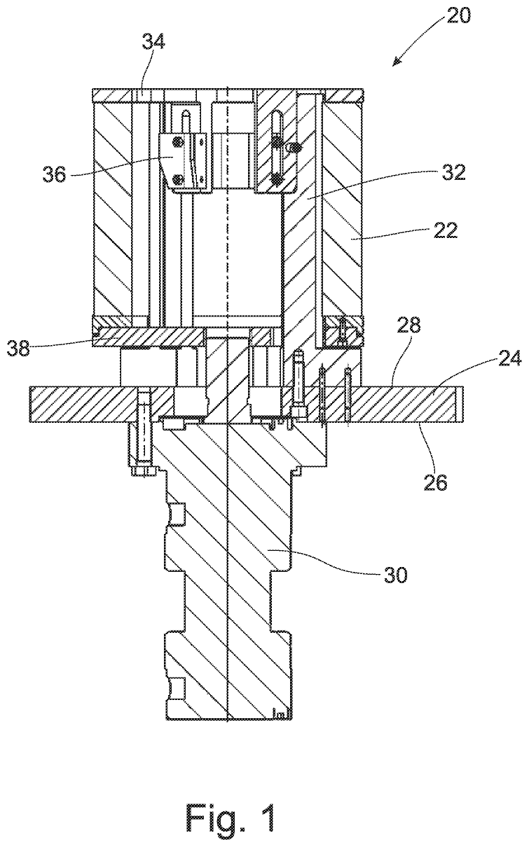

FIG. 1 shows a schematic representation of a workpiece carrier 20 for an installation 10 for the production of laminated cores, bonded over their entire surface, for an electrical machine.

For this purpose, the workpiece carrier 20 has a base plate 24 with a first side 26 and a second side 28 facing away from the first side 26. The first side 26 forms an underside and the second side 28 forms an upper side of the base plate 24.

On the second side 28 of the base plate 24, adjacent to the base plate 24, there is formed a multi-part pressing plate 38 and a cover 34, which is spaced therefrom and closable with a locking device 36. The workpiece carrier 20 can be loaded with the semi-finished product 22 between the pressing plate 38 and the cover 34 when the cover 34 is open and/or removed. A centring device 42, which is also aligned on the second side 28 of the base plate 24 and perpendicular thereto, enables the semi-finished product 22 to be precisely aligned. When the cover 34 is closed, the semi-finished product 22 is thus positioned between the pressing plate 38 and the cover 34 and adjacent to the centring device 32. In addition, the workpiece carrier 20 can accommodate several semi-finished products 22, which can, for example, be stacked on top of one another in the workpiece carrier 20.

On the second side 28 of the base plate 24, there is arranged a prestressing unit 30 designed as a hydraulic unit, which is adapted to exert an adjustable prestressing force on the semi-finished product 22 via the pressing plate 38 and the cover 34.

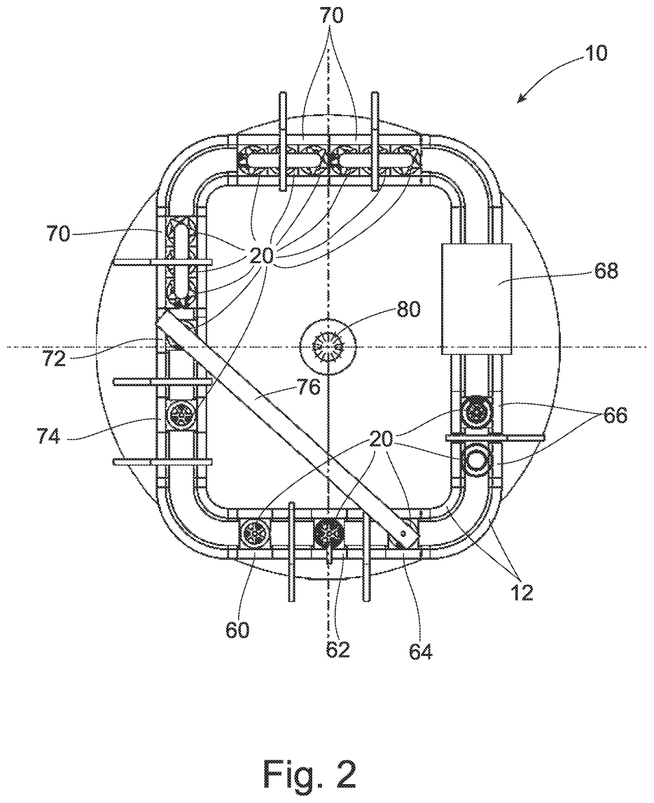

With further reference to FIG. 2, an installation 10 for producing laminated cores, bonded over their entire surface, for an electrical machine according to the first embodiment is shown in plan view.

As can be seen from FIG. 2, the installation 10 has a transport system 12, which is formed by two parallel rails and is arranged substantially in a circle around a centrally arranged hydraulic system 80.

The hydraulic system 80 comprises a pump, several valves, a control component for controlling the pressure prevailing in the hydraulic cylinder, as well as a corresponding measurement technology element for determining the pressure and other parameters.

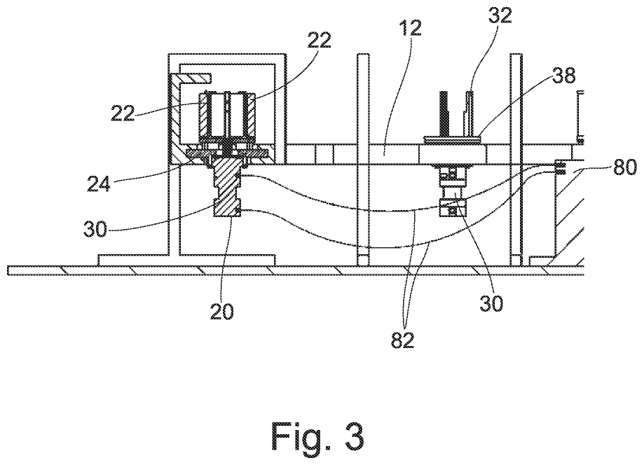

With further reference to the schematic side view shown in FIG. 3 of a detail of the installation 10 shown in FIG. 2, it can be seen that the workpiece carrier 20 with the base plate 24 is arranged on the transport system 12 in such a way that the second side of the base plate 24 with the semi-finished product 22 arranged thereon is easily accessible to an operator, so that the operator can easily insert a semi-finished product 22 into the workpiece carrier 20 and can remove the finished product, i.e. a laminated core, bonded over its entire surface, for a stator.

The prestressing unit 30 arranged on the first side 26 of the base plate 24 is connected to the centrally arranged hydraulic system 80 via a connecting line 82, for example a hose line or hydraulic line and possibly electrical lines, in such a way that a pressure imparted by the hydraulic system 80 to a hydraulic fluid can be applied to the semi-finished product 22 as an adjustable prestressing force via the connecting lines 82 and the prestressing unit 30. For reasons of clarity, only one connecting line 82 is shown. The connecting lines 82 of the other workpiece carriers 20 are designed accordingly. In this way, the prestressing force applied by the hydraulic system 80 can be controlled and the corresponding ACTUAL prestressing force can be documented. The hydraulic system 80 provides a high prestressing force with a small installation space and weight, whereby the size and weight of the workpiece carrier 20 can be reduced.

The transport system 12 enables the workpiece carrier 20 to be moved around the centrally arranged hydraulic system 80 at a substantially constant distance. The hydraulic system 80 is rotatably mounted and has a hydraulic rotary feedthrough with a stationary hydraulic unit, which is connected to the prestressing unit 30 of the workpiece carrier 20. This prevents twisting or winding of the connecting lines 82 during the rotation of several workpiece carriers 20.

With further reference to FIG. 2, a plurality of workpiece carriers 20 are arranged on the transport system 12 of the installation 10. The installation 10 has stations 60, 62, 64, 66, 68, 70, 72, 74 arranged above it on the transport system, through which the workpiece carriers 20 successively pass. The loading station 60 is intended to insert a semi-finished product into the workpiece carrier 20. In a subsequent checking station 62, the correct alignment of the semi-finished product in the workpiece carrier 20 is checked. In a subsequent closing station 62, the cover 34 is placed on the workpiece carrier 20 by a closing-opening device 27 and fixed to the workpiece carrier 20 by the locking unit 36. The semi-finished product 22 is then subjected to the desired prestress. In two subsequent warming stations 66, the second side 28 of the base plate 24 and thus also the semi-finished product 22 prestressed by the prestressing unit 30 is warmed by induction to a temperature below the bonding temperature, possibly irregularly. The advantage here is that induction-mediated warming takes little time. In a subsequent heating station 68, the semi-finished product 22 is heated to a bonding temperature of approximately 200° ° C. (or to a bonding temperature in a temperature range around 200° C.), wherein any temperature peaks caused by induction heating are equalized. Once the bonding temperature has been reached, the prestressing force applied to the semi-finished product 22 is successively reduced in order to prevent the Backlack from leaking out of the semi-finished product 22. In three subsequent cooling stations 70, the semi-finished product 22 is cooled to a desired temperature. The cooling stations 70 cool the semi-finished product 22 with energy assistance. For this purpose, the cooling stations 70 have fans (not shown) in order to cool the semi-finished product 22 in a subsequent opening station 74, the locking device 36 is opened and the cover 34 with the closure-opening device 76 is removed. In a subsequent step, the finished product is removed in the removal station 74. The workpiece carrier 20 can now be moved to the loading station 60 to carry out a new production cycle. The spatial separation of the stations 60, 62, 64, 66, 68, 70, 72, 74 enables not only the simultaneous use of several tool carriers 20, but also flexible adaptation to changed requirements, e.g. the connection of further stations 60, 62, 64, 66, 68, 70, 72, 74.

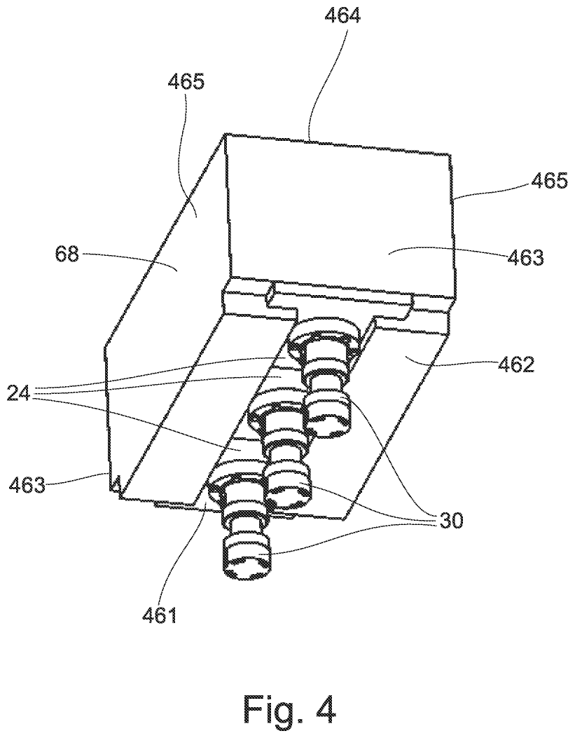

With reference to FIG. 4, the heating station of FIG. 2 is shown in a schematic oblique view.

The heating station 68, which is designed as a continuous furnace, is cuboid in shape with an underside 462, an upper side 464, two narrow sides 463 and two long sides 465. The underside 462 has a through-opening 461 extending between the narrow sides 463. The heating station is attached to the transport system 12 shown in FIG. 2 via the underside 462 in such a way that the through-opening 461 is aligned parallel to the transport system 12. Workpiece carriers 20 can be brought into the heating station 68 through a narrow side 463 in such a way that the base plate 24 closes an interior space of the heating station 68 in a heat-insulating manner and the prestressing unit 30 is present outside the heating station 68.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An installation for producing laminated cores, bonded over their entire surface, for an electrical machine, comprising:
a workpiece carrier configured to receive a semi-finished product and for applying a defined axial prestressing force to the semi-finished product, the semi-finished product having a plurality of electrical sheet laminations coated with Backlack, and
at least two stations, comprising a heating station configured to heat the semi-finished product and a cooling station providing energy-assisted cooling of the semi-finished product,
wherein the at least two stations, are arranged spatially separated from one another and are passed through by the workpiece carrier.

2. The installation according to claim 1, further comprising:
a loading station configured to load a workpiece carrier with a semi-finished product;
a checking station configured to check a height of a semi-finished product;
a closing station configured to close a workpiece carrier;
a warming station configured to warm a semi-finished product;
an opening station configured to open a workpiece carrier, and/or
a removal station for removing a finished product,
wherein the loading station, checking station, closing station and/or the heating station are arranged upstream of the heating station, and
wherein the opening station and/or the removal station are arranged downstream of the cooling station.

3. The installation according to claim 2,
wherein the workpiece carrier has a base plate with a first side and a second side facing away from the first side,
wherein a prestressing unit is arranged on the first side and the second side is configured to receive the semi-finished product and to apply the defined axial prestressing force to the semi-finished product by the prestressing unit.

4. The installation according to claim 1, further comprising a hydraulic system which is connected to a prestressing unit via connecting lines in such a way that the prestressing unit applies the defined axial prestressing force to the semi-finished product.

5. The installation according to claim 4, wherein the at least two stations, surround the hydraulic system such that a distance between the hydraulic system and the workpiece carrier is substantially constant.

6. The installation according to claim 1, wherein the installation has a transport system for the workpiece carrier.

7. The installation according to claim 1, wherein the heating station comprises a through-opening1 along one side thereof, wherein the workpiece carrier comprises a base plate which at least partially closes the through-opening1.

8. The installation according to claim 1, wherein a plurality of workpiece carriers pass through the installation simultaneously.

9. The installation according to claim 6, wherein the transport system is a rail system.

10. The installation according to claim 8, wherein one of the at least two stations is passed through simultaneously by the plurality of workpiece carriers.

11. A method for producing laminated cores, bonded over their entire surface, for an electrical machine, comprising:
providing a workpiece carrier adapted to receive a semi-finished product and configured to apply a defined axial prestressing force to the semi-finished product, the semi-finished product having a plurality of electrical steel laminations coated over their entire surface with Backlack; and
passing the workpiece carrier through at least two stations to heat the semi-finished product in a heating station and to cool the semi-finished product in a cooling station with energy assistance,
wherein the at least two stations are arranged spatially separated from one another.

12. The method according to claim 11, wherein the semi-finished product is heated in the heating station to a temperature which is in a temperature range around 200° C.
